(19) United States
(12) Patent Application Publication
(10) Pub. No.: US 2008/0225681 A1
(43) Pub. Date: Sep. 18, 2008

(54) OPTICAL RECORDING MEDIUM

(75) Inventors: Rumiko Hayase, Tsurumi-ku (JP); Akiko Hirao, Mihama-ku (JP); Kazuki Matsumoto, Saiwai-ku (JP); Satoshi Mikoshiba, Yamato-shi (JP); Sumio Ashida, Kanazawa-ku (JP); Tsukasa Nakai, Hino-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 12/042,014

(22) Filed: Mar. 4, 2008

(30) Foreign Application Priority Data
Mar. 13, 2007 (JP) 2007-064224

(51) Int. Cl. G11B 7/24

(52) U.S. Cl. 369/275.1

(57) ABSTRACT

According to an aspect of the present invention, there is provided an optical recording medium including a first substrate, a first adjusting layer, an organic recording layer, a second adjusting layer and a second substrate, sequentially stacked in the mentioned order. The first and second substrates have a refractive index of n1. The organic recording layer has a refractive index of n2. The first and second adjusting layers have a thickness of k and a refractive index distribution in a range of ns from a minimum value on sides contacting with the organic recording layer to a maximum value on sides contacting respectively with the first and second substrates. ns satisfies n2≦ns≦n1, and k satisfies 5≦k≦200 nm.

### CROSS-REFERENCE TO RELATED APPLICATIONS

The entire disclosure of Japanese Patent Application No. 2007-064224 filed on Mar. 13, 2007 including specification, claims, drawings and abstract is incorporated herein by reference in its entirety.

### BACKGROUND OF THE INVENTION

1. Field of the Invention

An aspect of the present invention relates to a hologram-type optical recording medium.

2. Description of the Related Art

A holographic memory for recoding information using a hologram is capable of recording a large capacity of information and is regarded as a notable recording medium in the next generation. As a hologram recording photo-sensitive composite, there is known a photopolymer represented by “OMNIDEX” (trademark) manufactured by DuPont Inc. which consists mainly of a photo-polymerizing monomer, matrix resin, a photo-polymerization initiator, and a sensitizing dye. Specifically, the hologram recording photo-sensitive composite is formed into a film-like shape and information is then recorded in the film-shaped hologram recording photo-sensitive composite by an interference exposure method. In the portion of the hologram recording photo-sensitive composite that light is radiated strongly on, radical polymerization progresses. When the radical polymerization progresses, a radical polymerizing monomer is spread from the light weakly radiated portion of the hologram recording photo-sensitive composite to the light strongly radiated portion thereof, thereby providing a concentration gradient. That is, according to the strength and weakness of the interference light, there is generated a density difference between the radical polymerizing monomers, resulting in a difference in the refractive index between the radical polymerizing monomers.

The hologram-type optical recording medium has a structure that a photopolymer is interposed between and held by two transparent plastic substrates. As the plastic substrate of the optical recording medium, there is used a substrate such as a polycarbonate substrate which is transparent and has a relatively high refractive index. As a photopolymer which functions as a recording layer, there is often used a photopolymer having lower refractive index than the plastic substrate. Since the hologram is a type of picture which records information according to refractive index modulation, when a difference in the refractive index between the plastic substrate and photopolymer is high, an error rate is high. JP-A-2004-279443 (KOKAI) discloses a technology in which an inorganic film is provided on a plastic substrate to thereby reduce the error rate. However, in this technology, because the relationship between the refractive indexes of the recording layer and inorganic film is not considered, the reduction of the error rate is insufficient. JP-A-2005-25851 (KOKAI) discloses that, during the sputtering with the sputtering target of silicone carbide (SiC) in a mixed gas composed of argon and oxygen, the ratio of carbon to oxygen and nitrogen can be controlled by changing the flow rate of oxygen and nitrogen, and thereby the refractive index of the resultant SiOC or SiOCN film can be changed while keeping the transparency thereof.

### SUMMARY OF THE INVENTION

According to an aspect of the present invention, there is provided an optical recording medium including: a first substrate that is transparent and has a refractive index of n1; a first adjusting layer that is disposed on the first substrate and has a thickness of k; an organic recording layer that is disposed on the first adjusting layer, the organic recording layer having a refractive index of n2 and capable of holographically recording an information thereon; a second adjusting layer that is disposed on the organic recording layer and has the thickness of k; and a second substrate that is disposed on the second adjusting layer, is transparent and has the refractive index of n1, wherein the first adjusting layer and the second adjusting layer have a refractive index distribution in a range of ns having: a minimum value on sides where the first adjusting layer and the second adjusting layer contact with the organic recording layer; and a maximum value on sides where the first adjusting layer contacts with the first substrate and the second adjusting layer contacts with the second substrate, wherein ns satisfies n2≦ns≦n1, and wherein k satisfies 5≦k≦200 nm.

### BRIEF DESCRIPTION OF THE DRAWINGS

Embodiment may be described in detail with reference to the accompanying drawings, in which:

FIG. 1 is a schematic sectional view of a hologram-type optical recording medium according to an embodiment of the present invention;

FIG. 2 is a schematic sectional view of a hologram-type optical recording medium according to an embodiment of the present invention;

FIG. 3 is a schematic view of an optical recording and reading apparatus according to an embodiment of the present invention;

FIG. 4 is a schematic view of a recording light pattern according to an embodiment of the present invention;

FIG. 5 is a schematic view of a reference beam pattern in reading according to an embodiment of the present invention;

FIG. 6 is a schematic sectional view of a hologram-type optical recording medium according to the first comparison example;

FIG. 7 is a schematic view of an optical recording and reading apparatus according to an embodiment of the present invention;

FIG. 8 is a schematic sectional view of a hologram-type optical recording medium according to an embodiment of the present invention; and

FIG. 9 is a graphical representation of variations in the beam radiation energy and internal diffraction efficiency in hologram-type optical recording mediums respectively according to the fifth embodiment, the sixth embodiment and the fifth comparison example.

### DETAILED DESCRIPTION OF THE INVENTION

Description will be given below of an embodiment of a hologram-type optical recording medium according to the invention with reference to the accompanying drawings. In the following description, the same parts are given the same designations and the duplicate description thereof will be omitted.

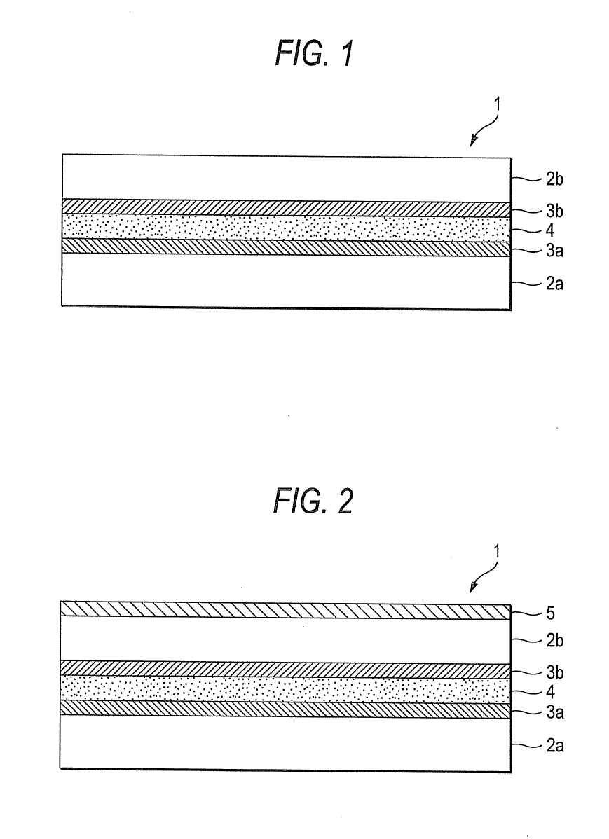

FIG. 1 is a schematic sectional view of a hologram-type optical recording medium according to an embodiment of the invention. In the hologram-type recording medium shown in FIG. 1, there are included a substrate 2a made of plastics, an adjusting layer 3a made of a SiOC film or a SiOCN film and capable of adjusting its refractive index, a recording layer 4, an adjusting layer 3b made of a SiOC film or a SiOCN film and capable of adjusting its refractive index, and a substrate 2b made of a plastic sequentially, while these composing parts are arranged sequentially in this order starting from the beam entrance direction.

The SiOC film is a film which contains Si, O and C as its composing elements and in which a total of at. % of Si, O and C provides 99% or more of the whole film. The SiOCN film is a film which contains Si, O, C and N as its composing elements and in which a total of at. % of Si, O, C and N provides 99% or more. The composing elements of the SiOC film or SiOCN can be analyzed qualitatively and quantitatively using XPS (X-ray photoelectron spectroscopy), AES (Auger electron spectroscopy), RBS (Rutherford Back Scattering), EPMA (Electron Probe Micro-Analysis), EDX (Energy Dispersive X-ray Fluorescence Spectrometer), ICP (Inductively Coupled Plasma), SIMS (Secondary Ion Mass Spectroscopy), or the like.

As the material of the substrates 2a, 2b, there is used a transparent material having a thickness ranging from several hundreds of μm to about 1 mm. Especially, there is used a transparent engineering plastic because it provides high mechanical strength. As the typical material of the plastic substrate, there can be pointed out polycarbonate, norbornene resin, cycloolefin resin, poly-arylate, methyl polymethacrylate, polystyrene, poly (ethylene dimethylacrylate), Polydiethyleneglycol-bis-allyl carbonate, polyphenylene oxide, polyethylene terephthalate, and the like.

As the material of the recording layer 4, preferably, there may be used a photopolymer. The photopolymer contains a polymer matrix, a photo-polymerizing monomer and a photo-polymerization initiator; and, as the need arises, there may be added a sensitizing dye such as a cyanine dye, a silane coupling agent, a plasticizer or the like. As the polymer matrix, there can be used thermoplastic resin, epoxy resin, urethane resin or the like. As the photo-polymerizing monomer, there can be used a radical polymerizing monomer (for example, unsaturated carboxylic acid, unsaturated carboxylic acid ester, unsaturated carboxylic acid amid and a vinyl compound), or a cationic polymerizing monomer (for example, epoxy, oxetane and vinyl ether). As the photo polymerization initiator, preferably, there may be used a radical polymerization initiator (for example, a benzophenone derivative, an organic azide compound, a titanocene material, an organic peroxide and a thioxantone derivative) or a cationic polymerization initiator (for example, onium salt, a sulfonic acid ester derivative, sulfonic acid amide derivative and a triazine derivative). The recording layer may have a thickness ranging from several tens μm to about 1 cm.

The refractive index of the substrates 2a and 2b is expressed as n1. The refractive index of the recording layer 4 is expressed as n2. Both of the adjusting layers 3a and 3b have refractive indexes distributed in a range of ns. The optical recording medium has such an inclined refractive index structure that the refractive indexes of the portions of the adjusting layers 3a and 3b disposed on the substrates 2a and 2b side are high and the refractive indexes of the portions of the adjusting layers 3a and 3b disposed on the recording layer side are low. The film thicknesses of the adjusting layers 3a and 3b, preferably, may be both set in the scope ranging from 5 nm to 200 nm. When the film thickness is less than 5 nm, the error rate reduction effect may not be obtained. For the thickness exceeding 200 nm, there may be a fear that, owing to carbon atoms and nitrogen atoms which are not combined with silicone atoms Si contained in the adjusting layers 3a and 3b, the reaction rate of the radical polymerization or cationic polymerization of the recording layer may be lowered and the recording sensitivity of the recording layer may be thereby lowered. More preferably, the thicknesses of the adjusting layers 3a and 3b may be set in the scope ranging from 10 nm to 100 nm.

The arithmetic average surface roughness Ra of the adjusting layers 3a and 3b is set such that 0.4≦Ra≦20 nm. When Ra is set to be 0.4 or more, they can provide proper adhesion with respect to the contact surfaces of the recording layer and substrates, thereby being able to prevent the volumetric contraction of the recording medium during recording. When Ra is set to be 20 nm or less, the influences of scattered light occurring on interfaces between the adjusting layers and recording layers as well as on interfaces between the adjusting layers and substrates can be reduced, thereby being able to reduce the error rate.

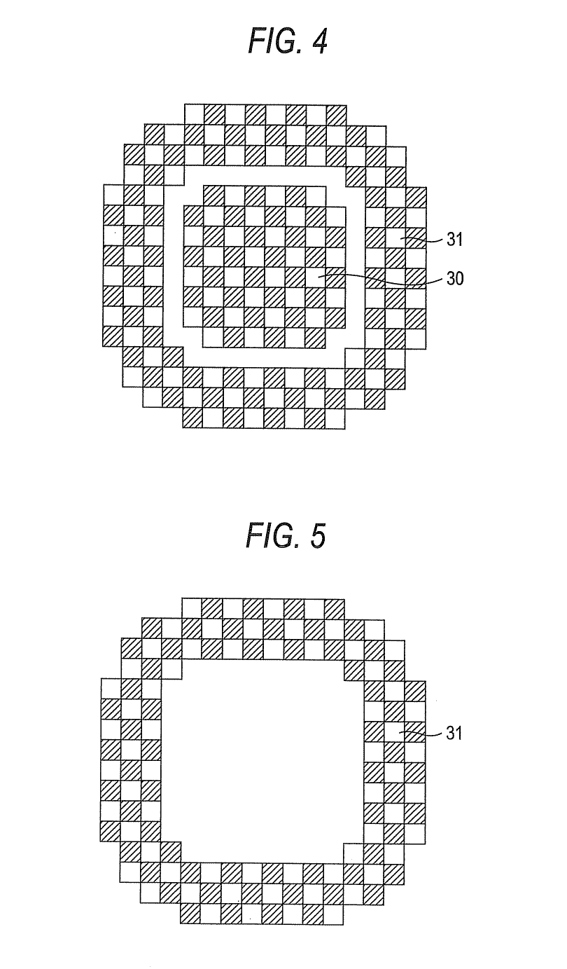

When the optical recording medium is used as a reflection recording medium, as shown in FIG. 4, it is also possible to provide, on the substrate 2b, a reflecting layer which is made of aluminum or the like.

### Embodiment

### First Embodiment

Next, description will be given below of the first embodiment. In the first embodiment, a series of operations have been carried out in the inside of a room where the light having a wavelength of less than 600 nm is shut out in order to prevent the recording layer from being photo-sensitized.

<Production of Hologram-Type Optical Recording Medium>

FIG. 2 is a schematic sectional view of a hologram-type optical recording medium according to the first embodiment. As a transparent plastic substrate, there were used polycarbonate substrates 2a and 2b each having a thickness of 0.6 mm (refractive index is 1.60). On one surface of the substrate 2b, there was previously vacuum evaporated an aluminum film 5 as a reflecting layer 5. On one-side surfaces (on the side where the reflecting layer is not disposed) of the two polycarbonate substrates, there were formed adjusting layers 3a and 3b each made of a SiOC film having a thickness of 30 nm using a Si+SiC target by a pulse mode DC sputtering method, respectively. A recording layer 4 and the two adjusting layers 3a, 3b were bonded together in such a manner that the recording layer 4 is held by and between the two adjusting layers 3a and 3b; and, there was produced a hologram-type optical recording medium having a layer structure in which the substrate 2a, adjusting layer 3a, recording layer 4, adjusting layer 3b, substrate 2b and reflecting layer 5 are put together sequentially in order starting from the incident direction of the recording light. In the film producing process, the flow rate of an argon gas and an oxygen gas was adjusted, whereby the refractive index of the substrate contact side of the SiOC film was set high and the refractive index of the recording layer contact side thereof was set low, while the values of these refractive indexes were inclined continuously.

In order to presume the refractive indexes of the portions of the SiOC film that respectively exist in the vicinity of the substrates and recording layer, the refractive indexes at the produced time of the films having a thickness of 5 nm and having a thickness of 30 nm respectively produced on the above-mentioned polycarbonate substrates under the same condition were measured respectively. According to the measurement, the refractive index of the film having a thickness of 5 nm was 1.58, while the refractive index of the film having a thickness of 30 nm was 1.50. Therefore, it can be supposed that the produced recording medium has an inclined refractive index structure in which the refractive index of the SiOC film on the substrate side is about 1.58 and the refractive index of the SiOC film on the recording layer side is about 1.50. The arithmetic average surface roughness Ra of the surface of the SiOC film was set for 1.53 nm. The surface roughness of the SiOC and SiOCN films was controlled by properly adjusting a voltage and the gas pressure of oxygen, nitrogen and the like in the sputtering time.

As the recording layer 4, there was used a photopolymer which includes a polymer matrix made of epoxy resin. 1.62 g of tetra ethylene pentammine and 6.04 g of 1,6-hexane diol glycidyl ether (which has an epoxy equivalent weight 151 and is manufactured by Nagase chemitex Co. Ltd.) were mixed together to thereby provide a matrix polymer precursor. Next, 1.352 g of N-vinyl carbazole functioning as a radical polymerizing compound and 0.041 g of IRGACURE 784 (manufactured by Ciba Specialty Chemicals Inc.) functioning as a photo-radical polymerization initiator were mixed together to thereby produce a uniform solution. This precursor solution was poured into between the above-mentioned two adjusting layers 3a and 3b (SiOC films) disposed through a spacer which is made of TEFLON (trademark) and has a thickness of 0.2 mm. Next, by keeping the thus prepared assembly at a room temperature (25° C.) for four days while shading the light, there was produced such a hologram-type optical recording medium as shown in FIG. 4.

The recording layer precursor solution was applied onto a glass piece and was similarly kept and hardened for four days while shutting out the light. After then, when the refractive index of the glass piece was measured, it was found 1.49. That is, the refractive index of the recording layer is supposed to be 1.49.

<First Medium Evaluation Method>

Next, description will be given below of a first medium evaluation method for an embodiment of the present invention in the following order: that is, an optical recording and reading apparatus, recording of information, reading of information, and evaluation.

<Optical Recording and Reading Apparatus>

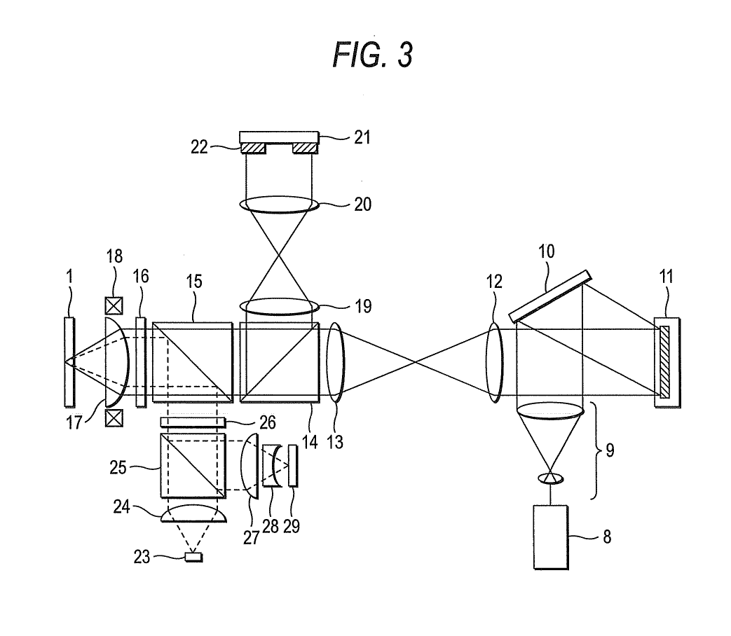

In order to evaluate the above-produced hologram-type optical recording medium, firstly, there was produced an optical recoding and reading apparatus as shown in FIG. 3.

The optical recoding and reading apparatus includes a hologram-type optical recording medium 1, a light source device 8, a beam expander 9, a mirror 10, a reflection-type space light modulator 11, a relay lens 12, a relay lens 13, a polarizing beam splitter 14, a dichroic prism 15, a light flashing optical element 16, an objective lens 17, a voice coil motor 18, an image forming lens 19, an image forming lens 20, a second dimension light detector 21, an iris 22, a light source device for servo 23, a collimate lens 24, a polarization beam splitter 25, a beam flashing optical element 26, a convex lens 27, a cylindrical lens 28 and a quadrant photo detector 29.

As a coherent light output from a light source device 8, there was used a GaN semiconductor laser (wavelength of 405 nm) which includes an external resonator and, as a light source device 23 for servo, there was used a semiconductor laser (wavelength of 650 nm) which was polarized linearly. As a reflection-type space light modulator 11, there was used a digital micro mirror device and, as a second dimension light detector 22, there was used a CCD array. As a light flashing optical element 16, there was used a ¼ wavelength plate for a wavelength of 405 nm and, as a flash light optical element 26, there was used a ¼ wavelength plate for a wavelength of 650 nm. The ¼ wavelength plate used as the light flashing optical element 16 was adjusted in the azimuth thereof such that the strength of a read light will be greatest on the second dimension light detector 22; and, the ¼ wavelength plate used as the flash light optical element 26 was also adjusted in the azimuth thereof such that the strength of a read light will be greatest on a quadrant photo detector 29.

<Recording of Information>

Next, the hologram-type optical recording medium produced by the above-mentioned manner was carried on the optical recording and reading apparatus (FIG. 3) and, while carrying out a servo control, there were actually recorded necessary pieces of information. The information recording was carried out using tracks respectively having a radius of 24 mm, 36 mm and 48 mm. In each track, four spots were recorded at intervals of 90 degrees. In the whole of the optical recording medium, twelve spots were recorded. The light strength on the surface of the hologram-type optical recording medium was 0.1 m W, while the exposure time was 0.1 second. The spot size (diameter) of a laser beam on the upper surface of the recording layer was about 400 μm. On the reflection-type space light modulator 11, there is displayed such a modulation pattern as shown in FIG. 4. The vicinity of the center of the optical axis of the reflection-type space light modulator 11 can be used as an information beam area 30, while the peripheral portion thereof can be used as a reference beam area 31.

In the reflection-type space light modulator 11, there was used an area which includes 160000 (400×400) pixels and, of this area, as an information beam area, there was used an area which includes 20736 (144×144) pixels existing in the central portion. In the information area, the information is treated as a total of 1296 panels, where a unit panel includes 16 (4×4) pixels. As a method for expressing the information, there was used a 16:3 modulation method in which, of 16 (4×4) pixels, three pixels are composed of light pixels. By this information expressing method, one panel can express 256 (1 byte) patterns and, as regards the information amount, there are provided 1296 bytes per spot.

<Reading>

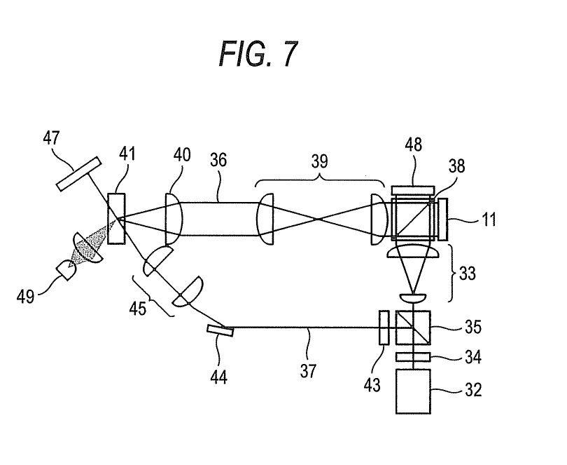

Next, there was carried out the reading of a hologram using a CCD array 21. In the reading, only the reference beam area 31 as shown in FIG. 5 was displayed on the reflection-type space modulator and was used as a reference beam. The light strength of the surface of the optical recording medium 1 was set for 0.01 m W.

<Evaluation>

Next, the recording and reading performance of the above-mentioned optical recording and reading apparatus, specifically, the error rate thereof was evaluated by the following method. On the CCD array 21, there was carried out an over-sampling operation in which the light from one pixel in the reflection-type space modulator 11 is received by 9 (3×3) pixels. As regards the error rate, on the CCD array 21, there was cut out an area of 432×432 pixels which corresponds to the information beam area, and the area was re-sampled to an area having a size of 144×144 pixels according to an image processing; after then, of a unit panel of 4×4, three pixels which are high in brightness were used as light pixels to thereby determine a reading pattern; and, finally, the reading pattern was compared with a pattern input to the reflection-type space light modulator 11 to evaluate the error rate. According to the result of the evaluation, the error rate in the four spots recorded in the hologram-type optical recording medium 1 was 1/5184.

### Second Embodiment

In the second embodiment, there was produced a hologram-type optical recording medium according to a method similar to the first embodiment. However, the thicknesses of the adjusting layers 3a and 3b, which are respectively made of SiOC, were both set for 50 nm. Also, the arithmetic average surface roughness Ra of the surface of the SiOC film was set for 1.67 nm. When the error rate of the hologram-type optical recording medium according to the second embodiment was measured by a similar medium evaluation method to the first embodiment, it was 2/5184.

### Third Embodiment

In the third embodiment, there was produced a hologram-type optical recording medium according to a method similar to the first embodiment. However, the thicknesses of the adjusting layers 3a and 3b, which are respectively made of SiOC, were both set for 50 nm. Also, the arithmetic average surface roughness Ra of the surface of the SiOC film was set for 4.00 nm. When the error rate of the hologram-type optical recording medium according to the third embodiment was measured by a similar medium evaluation method to the first embodiment, it was 1/5184.

### Fourth Embodiment

In the fourth embodiment, there was produced a hologram-type optical recording medium according to a method similar to the first embodiment. However, the refractive indexes of the substrates 2a and 2b were respectively set for 1.61, and the thicknesses of the adjusting layers 3a and 3b, which are respectively made of SiOC, were both set for 25 nm. Also, the refractive index of the SiOCN film near to the substrate was set for about 1.59, while the refractive index of the SiOCN film to be contacted with the recording layer was set for about 1.50. The arithmetic average surface roughness Ra of the surface of the SiOCN film was set for 1.40 nm. When the error rate of the hologram-type optical recording medium according to the fourth embodiment was measured by a similar medium evaluation method to the first embodiment, it was 1/5184.

### FIRST COMPARISON EXAMPLE

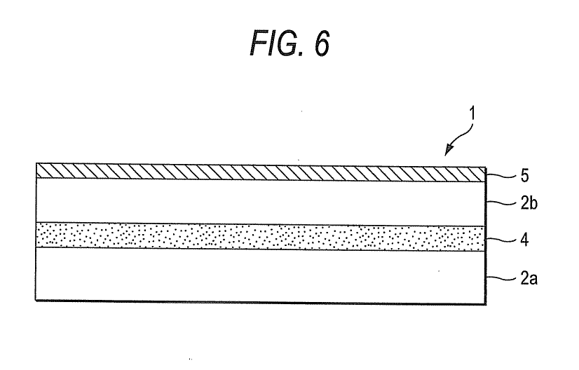

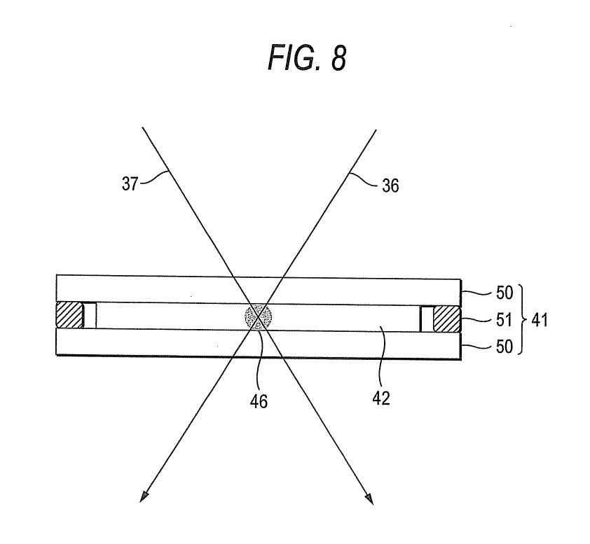

In the comparison example, there was produced a hologram-type optical recording medium according to a method similar to the first embodiment, except that a SiOC film functioning as an adjusting layer was not provided in the transparent polycarbonate substrates 2a and 2b. As shown in FIG. 6, in this comparison example, the hologram-type optical recording medium includes a substrate 2a made of plastics, a recording layer 4, a substrate 2b made of plastics and a reflecting layer 5 which are arranged sequentially in this order in the light incident direction. When the error rate of the hologram-type optical recording medium according to the first comparison example was measured by a similar medium evaluation method to the first embodiment, it was 67/5184.

### SECOND COMPARISON EXAMPLE

In the comparison example, there was produced a hologram-type optical recording medium according to a method similar to the first embodiment. However, since the film was produced while maintaining constant the flow rate of an argon gas and an oxygen gas, the produced SiOC film had a uniform refractive index in the film thickness direction and the refractive index was 1.55. The arithmetic average surface roughness Ra was set for 1.20 nm. When the error rate of the hologram-type optical recording medium according to the second comparison example was measured according to a similar medium evaluation method to the first embodiment, it was 18/5184.

### THIRD COMPARISON EXAMPLE

In the comparison example, there was produced a hologram-type optical recording medium according to a method similar to the first embodiment. However, the thicknesses of the adjusting layers 3a and 3b made of SiOC were both set for 210 nm. Also, the arithmetic average surface roughness Ra of the SiOC film was set for 1.53 nm. When the error rate of the hologram-type optical recording medium according to the third comparison example was measured by a similar medium evaluation method to the first embodiment, it was 22/5184.

### FOURTH COMPARISON EXAMPLE

In the comparison example, there was produced a hologram-type optical recording medium according to a method similar to the third embodiment, except that the arithmetic average roughness of the SiOC film was set for 30.00 nm. When the error rate of the hologram-type optical recording medium according to the fourth comparison example was measured by a similar medium evaluation method to the first embodiment, it was 45/5184.

### FIFTH COMPARISON EXAMPLE

In the comparison example, there was produced a hologram-type optical recording medium according to a method similar to the fourth embodiment, except that the arithmetic average roughness of the SiOC film was set for 0.30 nm. When the error rate of the hologram-type optical recording medium according to the fourth comparison example was measured by a similar medium evaluation method to the fourth embodiment, it was 9/5184.

### Fifth Embodiment

<Production of Hologram-Type Optical Recording Medium>

As shown in FIG. 1, in the fifth embodiment, as transparent plastic substrates, there were used polycarbonate substrates 2a and 2b (refractive index of 1.62) each having a thickness of 0.6 mm. On the respective one-side surfaces of the substrates 2a and 2b, there were formed adjusting layers 3a and 3b each made of a SiOC film having a thickness of 30 nm by a pulse mode DC sputtering method using a Si+SiC as a target. While a recording layer 4 and the two adjusting layers 3a, 3b were bonded together in such a manner that the recording layer 4 was held by and between the two adjusting layers 3a and 3b, there was produced a hologram-type optical recording medium having a layer structure in which the substrate 2a, adjusting layer 3a, recording layer 4, adjusting layer 3b and substrate 2b are put together sequentially in this order when viewed from the incident direction of the recording light. In the film producing process, the flow rate of an argon gas and an oxygen gas was adjusted, whereby the refractive index of the substrate contact side of the SiOC film was set high and the refractive index of the recording layer contact side thereof was set low, while the values of the refractive index were inclined continuously.

In order to presume the refractive indexes of the respective portions of the adjusting layers 3a and 3b (SiOC film) that exist in the vicinity of the substrates and recording layer, the refractive indexes at the produced time of the films respectively having a thickness of 5 nm and having a thickness of 30 nm produced on the above-mentioned polycarbonate substrates under the same conditions were measured respectively. According to the measurement, the refractive index of the film having a thickness of 5 nm was 1.60, while the refractive index of the film having a thickness of 30 nm was 1.49. Therefore, it can be supposed that the produced recording medium has an inclined refractive index structure in which the refractive index of the SiOC film on the substrate side is about 1.58 and the refractive index of the SiOC film on the recording layer contact side is about 1.50. Also, the arithmetic average surface roughness Ra of the surface of the SiOC film was 0.98 nm.

As the recording layer 4, there was used a photopolymer which includes a polymer matrix made of epoxy resin. 1.215 g of tetra ethylene pentammine and 4.53 g of 1,6-hexane diol glycidyl ether (which has an epoxy equivalent weight 151 and is manufactured by Nagase chemitex Co. Ltd.) were mixed together to thereby provide a matrix polymer precursor. Next, 1.077 g of N-vinyl carbazole functioning as a radical polymerizing compound and 0.359 g of IRGACURE 369 (manufactured by Ciba Specialty Chemicals Inc.) functioning as a photo-radical polymerization initiator were mixed together to thereby produce a uniform solution. This precursor solution was poured into between the above-mentioned two adjusting layers 3a and 3b (SiOC films) disposed through a spacer which is made of TEFLON (trademark) and has a thickness of 0.2 mm. Next, by keeping the thus prepared assembly at a room temperature (25° C.) for four days while shutting off the light, there was produced a hologram-type optical recording medium.

The recording layer precursor solution was applied onto a glass piece and was similarly kept and hardened for four days while shutting off the light. After then, when the refractive index of the glass piece was measured, it was found 1.49.

<Second Medium Evaluation Method>

In order to evaluate a transmission-type hologram-type optical recording medium, there was produced an optical recording and reading apparatus which uses a two-beam interference method shown in FIG. 7. As a coherent beam to be output from the light source device 32, there was used a GaN semiconductor laser (wavelength of 405 nm) including an external resonator. As the reflection-type space light modulator 11, there was used a reflection-type liquid crystal panel and, as a two-dimensional light detector 48, there was used a CCD array. As light flashing optical elements 34, 43, there were used ½ wavelength plates for a wavelength of 405 nm. The ½ wavelength plate used as the light flashing optical element 43 was adjusted in the azimuth thereof such that an information beam 36 in a hologram-type recording medium 41 and a reference beam 37 are equal to each other in the polarizing direction. And, the ½ wavelength plate used as the light flashing optical element 34 was adjusted in the azimuth thereof such that the contrast of a hologram to be recorded in the hologram-type recording medium 41 can be greatest. In order to stabilize the hologram, after recording, there may also be radiated a beam using an ultraviolet light source device 49 to polymerize an un-reacted radical polymerizable compound. As the ultraviolet light source device 49, there may be used any light source device, provided that it can radiate such beam as can polymerize the un-reacted radical polymerizable compound. Here, when an ultraviolet beam emission efficiency is taken into account, preferably, for example, there may be used a xenon lamp, a mercury lamp, a high pressure mercury lamp, a mercury xenon lamp, a GaN light emitting diode, a GaN semiconductor laser, an excimer laser, the third higher harmonic wave (355 nm) of a Nd:YAG laser, and the fourth higher harmonic wave (266 nm) of a Nd:YAG laser.

<Recording of Information>

The hologram-type optical recording medium was carried on the optical recording and reading apparatus (FIG. 7) and information was actually recorded. The information recording was carried out using an angle multiple recording method in which a mirror 44 is driven to vary the incident angle of the reference beam 37 page by page. A recording spot was set to have a radius of 3 mm, the angle interval of the reference beam was 0.50, the number of pages to be multiplied was set for 40, and the recording characteristics were evaluated using the thus read images. The light strength on the surface of the optical recording medium was 0.5 mW, while the exposure time per page was 1 second. On the reflection-type space light modulator 11, there was displayed only the information beam area 30 shown in FIG. 4. In the information beam area there is used an area which includes 20736 (144×144) pixels and, of this area, 16 (4×4) pixels are used as a unit panel, while the information is treated as a total of 1296 panels. As a method for expressing the information, there was used a 16:3 modulation method in which, of 16 (4×4) pixels, three pixels are composed of light pixels and also in which one panel can express 256 (1 byte) patterns and, as the information amount, there are provided 1296 bytes per page.

<Reading>

There was carried out the reading of a hologram using a CCD array 48. In the reading, the light flashing optical element 34 was turned and only the reference beam was radiated onto the optical recording medium. A mirror 47 was adjusted such that the reference light can be reflected vertically, while the light flashing optical element 43 was adjusted in the azimuth thereof such that the light strength of a reading light obtained by the CCD array 48 can be greatest. The light strength of the optical recording medium in the reading was set for 0.5 mW.

<Evaluation>

The recording and reading performance of the above-mentioned optical recording and reading apparatus, specifically, the error ratio thereof with respect to 40 pages, a total of 51840 bytes was evaluated by a method similar to the method described in the first medium evaluation method. According to the result of the evaluation, the error ratio in the four spots recorded in the hologram-type optical recording medium 6 was 1/5184.

### Sixth Embodiment

In the present embodiment, there was produced a hologram-type optical recording medium according to a method similar to the fifth embodiment. However, the thicknesses of the adjusting layers 3a and 3b, which are respectively made of SiOCN, were both set for 70 nm. Also, the refractive index of the SiOCN film near to the substrate was set for about 1.61, while the refractive index of the SiOCN film to be contacted with the recording layer was set for about 1.50. And, the arithmetic average surface roughness Ra of the surface of the SiOCN film was set for 1.20 nm.

When the angle multiple recording was carried out according to a method similar to the fifth embodiment, the error ratio thereof was 2/5184.

### FIFTH COMPARISON EXAMPLE

In the present comparison example, there was produced a hologram-type optical recording medium similarly to the fifth embodiment, except that the SiOCN film was not provided on the polycarbonate substrate. When the angle multiple recording was carried out according to a method similar to the fifth embodiment, the error ratio thereof was 23/5184.

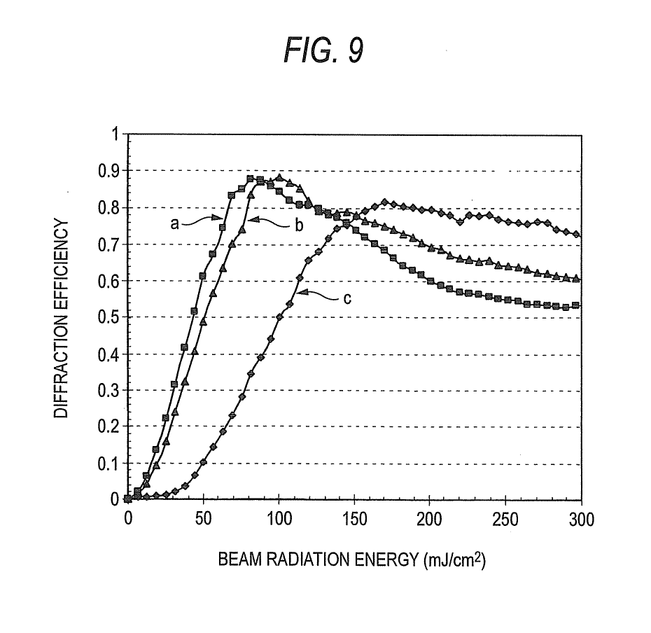

The characteristics of the respective recording mediums were evaluated using the optical recording and reading apparatus shown in FIG. 7 in the following manner: that is, the information beam 36 and reference beam 37 were radiated onto the recording medium 41 continuously without changing the angles thereof and variations in the beam radiation energy and internal diffraction efficiency were recorded. The evaluation results of the holograms of the fifth embodiment, the sixth embodiment and the fifth comparison example are shown in FIG. 9. In FIG. 9, curved lines a, b and c respectively show the evaluation results of the fifth embodiment, the sixth embodiment and the fifth comparison example. This evaluation result can prove that to coat the substrate with the SiOC film or SiOCN film functioning as the adjusting layer can provide a high diffraction efficiency with less beam radiation energy.

It should be emphasized that the above-described embodiments, are merely possible examples of implementations, merely set forth for a clear understanding of the principles of the invention. Many variations and modifications may be made to the above-described embodiments without departing substantially from the spirit and principles of the invention.

For example, the substrates 2a and 2b may be formed so as to have same thickness, or to have thicknesses different with each other. And, the adjusting layers 3a and 3b may be formed so as to have same thickness, or to have thicknesses different with each other.

Additionally, for example, the substrates 2a and 2b may be formed so as to have same refractive index, or to have refractive indexes different with each other. And, the adjusting layers 3a and 3b may be formed so as to have same refractive index, or to have refractive indexes different with each other.

What is claimed is:

1. An optical recording medium comprising:
a first substrate that is transparent and has a refractive index of n1;
a first adjusting layer that is disposed on the first substrate and has a thickness of k;
an organic recording layer that is disposed on the first adjusting layer, the organic recording layer having a refractive index of n2 and capable of holographically recording an information thereon;
a second adjusting layer that is disposed on the organic recording layer and has the thickness of k; and
a second substrate that is disposed on the second adjusting layer, is transparent and has the refractive index of n1, wherein the first adjusting layer and the second adjusting layer have a refractive index distribution in a range of ns having:
a minimum value on sides where the first adjusting layer and the second adjusting layer contact with the organic recording layer; and
a maximum value on sides where the first adjusting layer contacts with the first substrate and the second adjusting layer contacts with the second substrate,
wherein ns satisfies n2≦ns≦n1, and
wherein k satisfies 5≦k≦200 nm.

2. The optical recording medium according to claim 1, wherein k further satisfies 10≦k≦100 nm.

3. The optical recording medium according to claim 1, wherein the first adjusting layer and second adjusting layer include SiOC or SiOCN.

4. The optical recording medium according to claim 1, wherein the first adjusting layer and the second adjusting layer have an arithmetic average surface roughness of Ra that satisfies 0.4≦Ra≦20 nm.

5. The optical recording medium according to claim 1 further comprising a reflecting layer that is disposed on an opposite side of the second substrate to the organic recording layer.

6. The optical recording medium according to claim 1, wherein the first substrate and the second substrate is formed by resin material.

7. An optical recording and reading apparatus for the optical recording medium according to claim 1, the optical recording and reading apparatus comprising:
a first light source that outputs a first beam;
a light modulator that modulates the first beam;
a first optical unit that guides the first beam to the optical recording medium via the light modulator;
a second light source that outputs a second beam;
a second optical unit that guides the second beam to the optical recording medium; and
a detector that detects a reflected beam from the optical recording medium.

8. An optical recording and reading apparatus for the optical recording medium according to claim 1, the optical recording and reading apparatus comprising:
a light source that outputs a beam;
a beam splitter that splits the beam into a first beam and a second beam;
a light modulator that modulates the first beam;
a first optical unit that guides the first beam to the optical recording medium via the light modulator;
a second optical unit that guides the second beam to the optical recording medium; and
a detector that detects a diffracted beam from the optical recording medium.
